(19) United States
(12) Patent Application Publication
(10) Pub. No.: US 2010/0108443 A1
(43) Pub. Date: May 6, 2010

(54) ELECTRONIC STAIRS BARRIER AND GUIDE

(76) Inventor: CHIDI UCHE, Witney (GB)

Correspondence Address: DR. CHIDI UCHE, 84 Green Road, Kidlington, Oxfordshire, OX5 2HA, GB

(21) Appl. No.: 12/391,973

(22) Filed: Feb. 24, 2009

(30) Foreign Application Priority Data
Jul. 12, 2007 (GB) 0713537.9

(51) Int. Cl. E04F 11/18; A62B 99/00

(52) U.S. Cl. 182/137

(57) ABSTRACT

An automatic/active/intelligent stair guide system that will allow children, elderly, disabled or frail people to use the stairs safely by acting as an instant barrier stopping a child or an elderly or frail person from falling even after they have lost their grip on the stairs.

Preferably the system can be deployed in any of the three forms firstly as successive barrier(s) in front or behind anyone climbing or descending the stairs, secondly as a single or group of barriers following/tracking the person on the stairs and thirdly as foldable units located at the rungs/step of a stairway that are activated manually or automatically.

### CROSS-REFERENCE TO RELATED APPLICATIONS

Prior application of this invention has been made at the United Kingdom's Patent Office. The following are the details of the application:

Filing Date: 12 Jul. 2007

Application Number is GB0713537.9

It is the same invention that is being patented in the United Kingdom that is contained in this application.

### BACKGROUND OF THE INVENTION

This invention is concerned with a system for preventing accidental fall of children and elderly people from stairs. Fall from stairs has been cited as one of the major cause of death and among children, elderly or disabled people. A number of passive fall prevention devices such as stair fences and rail guides have been known but the stair fences are most suitable for toddlers and restrict childrens' movement and stop children from totally using the stairs while the rail guides allow the movement of children, disabled or elderly people but do not prevent them from falling down from stairs once they have lost their grip.

### BRIEF SUMMARY OF INVENTION

The object of this invention is to provide a new and active stair guide system that will allow children, disabled or elderly people to use the stairs while acting as an instant barrier stopping a child, disabled or an elderly person from failing even after they have lost their grip on a stair rail.

### BRIEF DESCRIPTION OF THE SEVERAL VIEW OF THE DRAWING

The preferred embodiments of the invention will be described with reference to the accompanying drawings in which:

FIG. 1 shows the first form of the invention consisting of a fixed unit (Module 1) that is mounted on the wall or other suitable locations and a second movable vertical or horizontal barrier (Module 2) that is activated to prevent or break the fall of a child, disabled or an elderly person and Module 2 rides along a track on Module 1 and tracks the movement of a child, disabled or elderly person.

FIG. 2 shows the second form of the invention consisting of a Module 1 and a fixed Module 2 that consists of a row of barriers (deployed vertical as in FIG. 2A or horizontally or as in FIG. 2B) and once a child, disabled or elderly person is on the stairs each of the barrier will be activated and flipped into position successively based on the location of the child, disabled or elderly on the stairs in order to provide a barrier if they fall.

FIG. 3 shows the third form of the invention that comprises of a foldable or shutter-type units (Module 3) that can be installed at each rung of the step. When a child, disabled or elderly person is climbing up or down the stairs, the units are activated successively based on the location of the child, disabled or elderly person on the stairs.

### DETAILED DESCRIPTION OF THE INVENTION

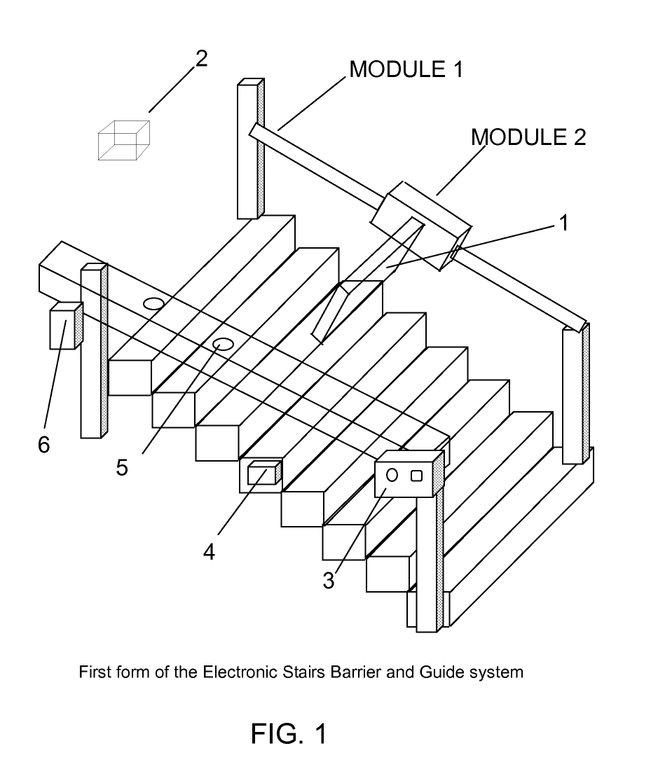

In the first form of this invention shown in FIG. 1 this invention provides an electronic stair guide system consisting of a fixed unit (Module 1—made of suitable metal, plastic, fibre or any other solid material) that is mounted on the wall or other suitable locations and a second movable vertical or horizontal barrier (Module 2—made of suitable metal, plastic, fibre or any other solid material) that is activated by the sensors 2 positioned on the stairs to prevent or break the fall of a child, disabled or an elderly person and Module 2 rides along Module 1 and tracks the movement of a child, disabled or elderly person and will actively provide a barrier 1 behind the child, disabled or elderly person when they are climbing up or a barrier 1 in front of the child, disabled or elderly person when they are climbing down. Module 1 can be powered electrically e.g. using electrical motors or magnetically using magnetic induction or mechanically using suction, thermal expansion or similar processes or optically. Other power sources can be used for the system.

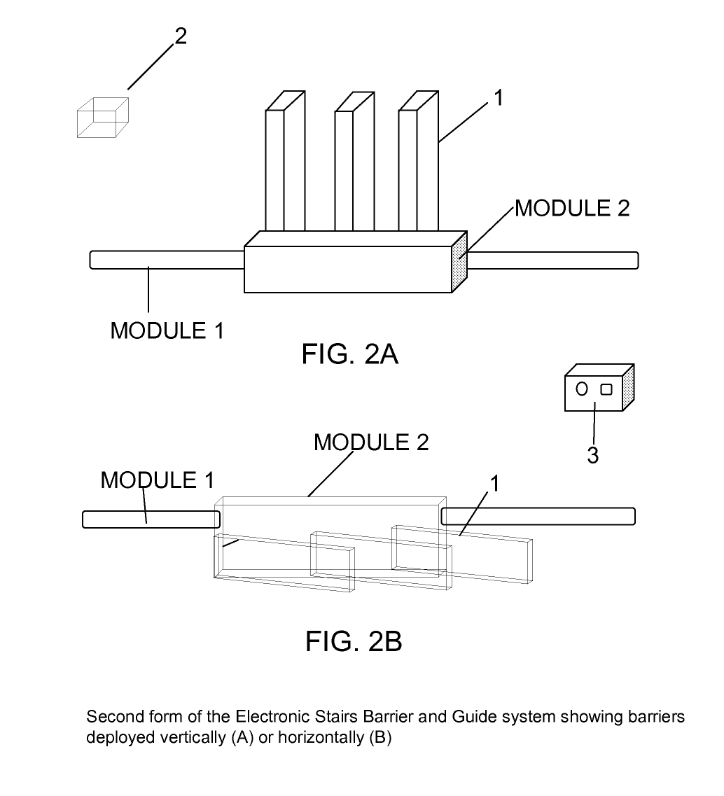

The second form this invention as shown in FIGS. 2A and B consists of a Module 1 (made of suitable metal, plastic, fibre or any other solid material) and a fixed Module 2 (made of suitable metal, plastic, fibre or any other solid material) that consist of row of barriers (originally in a vertical or horizontal position) and once a child, disabled or elderly person is on the stairs the sensors 2 positioned on the stairs activates the system and each of the barrier 1 will be activated and flipped into position successively based on the location of the child, disabled or elderly on the stairs.

In the third form the stairs barrier and guide system comprise of a foldable or shutter-type units (Module 3) that can be installed at each rung of the step and when a child, disabled or elderly person is climbing up or down the stairs, the units are activated by the sensors 2 successively based on the location of the child, disabled or elderly person on the stairs and the barrier 1 for each unit could be made of tough fibre or plastic (for easy automatic repacking/refolding after activation) or can be made of rubber or metal. As many of the units can be installed as required.

As shown in FIG. 1 in the first form of the system one or more barriers 1 following the child or adult up or down the stairs and will actively provide a barrier 1 behind a child or adult when they are climbing up the stairs or a barrier 1 in front of a child or adult when they are climbing down the stairs.

If the system is in operation a sensor 2 measures the height and speed of anyone climbing the stairs and together with information about the user's weight from sensors such as strain gauges 4 embedded in the stairs determines if the person on the stairs is an adult or a child. If there is only one person on the stairs, the barrier 1 will always be activated. When there are more than one person climbing the stairs the system can be set to be deactivated on special occasions for example when a child is climbing up the stairs and an adult is on a lower rung than the child. The system can be set to be deactivated in this case as the adult on the stairs can stop a child falling further down the stairs. However if a person is climbing the stairs and another person (whose height is NOT recognised as an adult e.g. a child) enters the stairs, the system will not be deactivated and will keep protecting the child or elderly person who is climbing.

Equally the user can set the height or weight which the system will recognize as the height or weight of an adult using the system control unit 3. Systems can be designed to be ON by default but a button on the control unit 3 can be used to deactivate the system if it is not needed on any occasion.

As shown in FIG. 2 in the second form of the invention, Module 2 of the electronic barrier and guide system would consist of rows of vertical or horizontal barriers 1 positioned along the stairs. When a child enters the stairway, the sensors 2 will switch the device ON (the sensors 1 are positioned at various locations on the stairway and are placed at various levels). Based on the location of the child one or more barriers 1 will be activated and moved into position. Barriers 1 will be activated in succession hence rows of barriers 1 will be activated along the stairs each one activating at the right time. Barriers 1 will be activated behind a child, disabled or elderly person when they are climbing up the stairs or in front of the child, disabled or elderly person when they are climbing down the stairs. The barriers 1 will be activated at such a point to leave enough space between a child, disable or elderly person and the unfolding barrier 1.

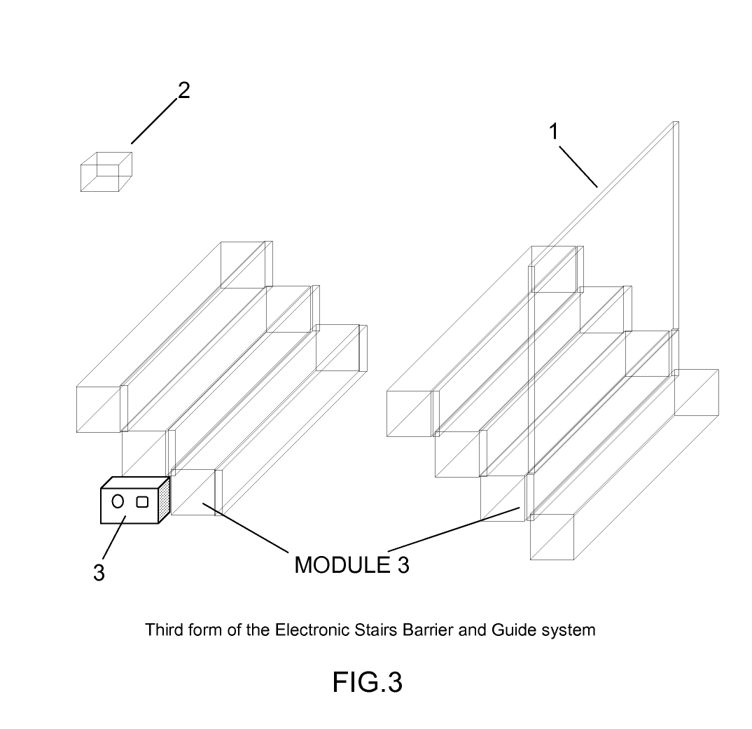

As shown in FIG. 3 the third form of the stair barrier and guide system will consist of sets of shutter-type units (Module 3). All the units installed are connected to a central controlling system 3 which has as an input many sensors 2, 4 (to detect motion, vibration, height, weight etc) strategically located on the stairs. When significant impact is detected say by a child falling down a stair, the processing unit 3 activates rows of units further down the stairs to break the fall of the child. The barrier for each unit could be made of tough fibre or plastic (for easy automatic repacking/refolding after activation) or can be made of rubber or metal. As many of the units can be Installed as required.

For all the three forms of the electronic stairs barriers and guide system the sensors 2,4 can be positioned at various levels and locations on the stairway and are used to activate the system and the sensors can be contact or non-contact sensors and can be of any type such as motion, optic/image recognition, electrical, acoustic, magnetic, inductive, capacitive, vibration or any other type of sensor. The whole system or part of the system can be made of any material such as metals, plastic, wood or any other material such as lightweight materials.

The barrier could be made of any rigid or shock resistant/absorbent material or any foldable or flexible material such as tough fibre, plastic, rubber or any other material for easy automatic repacking/refolding after activation. The whole system or part of the system including the barrier could be made of green or recyclable materials. Non-toxic/baby-friendly materials should also be used. Fire-resistant materials should also be used for the system including the barriers.

For added safety during the night, the whole system or part of the system including the barrier could be made of fluorescent materials and parts of the system can be illuminated using LED, bulbs or any other suitable light source or device 5.

The whole system or part of the system including the barrier should be made water-proof hence they can be used in wet environments and also to provide electrical isolation. The system will also be capable of activating an alarm 6 when someone falls on the stairs or hits the barrier during a fall. The speed at which the barrier is deployed can be either manually using the control unit 3 or automatically adjustable or both.

The stairs barrier and guide system can be powered electrically or mechanically and can be wound up using a rechargeable supply or any other power sources. Ordinarily the system would normally be ON but a switch on the control unit 3 can be used for deactivating the system if a user does not need assistance going up or down the stairs.

The whole system or part of the system such as the barrier is detachable and can easily be dismantled for cleaning. The system can also be permanently fixed to the stairs or can be temporarily set-up or mounted using clips, magnets, Velcro or any other method. The system will be foldable and adjustable to fit the layout and contour of any stairway.

1. An automatic/active/intelligent stair guide system that will allow children, elderly, disabled or frail people to use the stairs safely by acting as an instant barrier stopping a child or an elderly or frail person from falling even after they have lost their grip on the stairs.

2. An automatic system as described in claim 1 where a barrier or barriers located on the stairs are activated as successive rows behind or before a child, elderly or frail person on any stairs when ascending or descending the stairs respectively and the barriers will be activated at such a point to leave enough space between the person climbing or descending the stairs and the unfolding barrier.

3. An automatic system as described in claim 1 where a barrier or barriers track/follow a child or elderly, or frail person up or down any stairs.

4. A system as claimed in 1-3 where the system can be set to deactivate when a person of certain weight greater than a set weight steps on the stairs behind the child or elderly or frail person climbing the stairs or in front of the child, elderly or any person climbing the stairs otherwise the system is not deactivated because of the new person on the stairs.

5. A system as claimed in claim 4 where the system can equally be set to deactivate if a person of a height greater than a set of heights steps on the stairs behind the person climbing the stairs or in front of the person climbing the stairs otherwise the system is not deactivated because of the new person on the stairs.

6. A system that can allow anyone to set heights or a combination of heights and weights which the system will classify as belonging to children or adults.

7. A system as claimed in claim 1-6 where the system can be started either manually by the user using a switch or similar devices or started automatically.

8. A system as claimed in claim 7 which is ON by default but a button can be located at each end of a stairway to deactivate the system if it is not needed on any occasion.

9. A system as claimed in claim 1-8 consisting of a fixed unit (Module 1) that is mounted on the wall or other suitable locations and a second movable vertical or horizontal barrier (Module 2) that is activated to prevent or break the fall of a child, an elderly, disabled or frail person and Module 2 rides along a track on Module 1 and tracks the movement of the people climbing the stairs and will actively provide a barrier behind the person or people when they are climbing up or a barrier in front of the person or people when they are climbing down.

10. A system as claimed in claim 1-8 consisting of a Module 1 and a fixed Module 2 that consist of row of barriers and once activated manually or automatically will be flipped into position successively based on the location of the person climbing the stairs.

11. A system as claimed in claim 1-8 that comprises of a foldable or shutter-type units (Module 3) that can be installed at each rung of the stairs and when a child or an elderly person is climbing up or down the stairs, the units are manually or automatically activated successively based on the location of the child or elderly or frail person on the stairs and the barrier for each unit could be made of tough fibre (for easy automatic repacking/refolding after activation) or can be made of rubber or metal. As many of the units can be installed as required.

12. A system as claimed in claim 11 comprising of foldable or shutter-type units where all the units installed are connected to a central controlling system which has as an input many sensors 1 (to detect motion, vibration, height, weight etc) strategically located on the stairs. When significant impact is detected say by a child falling down a stair, the processing unit activates rows of units further down the stairs to break the fall of the child.

13. A system as claimed in claim 1-12 which can be permanently fixed to the stairs or can be temporarily set-up or mounted using dips, magnets, Velcro or any other method.

14. A system as claimed in claim 1-12 which is foldable and adjustable to fit the layout and contour of any stairway.

15. A system as claimed in claim 1-14 where sensors are positioned at various levels and locations on the stairway and are used to activate the system and the sensors can be contact or non-contact sensors and can be of any type such as motion, optic/image recognition, electrical, acoustic, magnetic, inductive, capacitive, vibration or any other type of sensor.

16. A system as claimed in claim 1-15 where the whole system or part of the system is made of any material such as metals, plastic, wood or any other material such as lightweight materials.

17. A system as claimed in claim 1-16 where the barrier could be made of any rigid or shock resistant/absorbent material or any foldable or flexible material such as tough fibre, rubber or any other material for easy automatic repacking/refolding after activation.

18. A system as claimed in claim 1-17 where the whole system or part of the system including the barrier is made of green or recyclable materials.

19. A system as claimed in claim 1-18 where the whole system or part of the system including the barrier is made of non-toxic/baby-friendly materials.

20. A system as claimed in claim 1-19 where the whole system or part of the system including the barrier is made of fire-resistant materials.

21. A system as claimed in claim 1-20 where the whole system or part of the system including the barrier is made of fluorescent materials and parts of of the system can be illuminated using LED, bulbs or any other device.

22. A system as claimed in claim 1-21 where the whole system or part of the system including the barrier are made water-proof hence they can be used in wet environments and also to provide electrical isolation.

23. A system as claimed in claim 1-22 where an alarm is activated when some someone hits the barrier during a fall.

24. A system as claimed in claim 1-23 where the speed at which the barrier is deployed is manually or automatically adjustable.

25. A system as claimed in claim 1-24 where the system is powered electrically, mechanically/can be wound up, using a rechargeable supply or any other power supply.

26. A system as claimed in claim 1-25 where the whole system or part of the system such as the barrier is detachable and can easily be dismantled for cleaning.

27. A system substantially as herein described and illustrated in the accompanying drawings.
